(19) United States
(12) Patent Application Publication
(10) Pub. No.: US 2018/0096313 A1
(43) Pub. Date: Apr. 5, 2018

(54) LINKED CONTRACT SYSTEM AND METHOD

(71) Applicant: MonetaGo Inc., New York, NY (US)

(72) Inventors: Jesse R. Chenard, New York, NY (US); Patrick E. Manasse, New York, NY (US); Paul R. Davis, III, Jersey City, NJ (US); Brendan L. Taylor, New York, NY (US)

(21) Appl. No.: 15/833,442

(22) Filed: Dec. 6, 2017

Related U.S. Application Data
(63) Continuation-in-part of application No. 15/699,663, filed on Sep. 8, 2017.
(60) Provisional application No. 62/430,646, filed on Dec. 6, 2016.
(60) Provisional application No. 62/385,517, filed on Sep. 9, 2016.
(60) Provisional application No. 62/385,533, filed on Sep. 9, 2016.

(51) Int. Cl. G06Q 20/02; G06Q 20/10

(52) U.S. Cl. CPC G06Q 20/027; G06Q 20/10

(57) ABSTRACT

A computer-implemented method, computer program product and computing system for effectuating an asset transfer between a plurality of banks includes generating a plurality of linked smart contracts, wherein the plurality of linked smart contracts includes: a first smart contract within a first banking network, and a second smart contract within a second banking network. The asset transfer between the plurality of banks is processed via the plurality of linked smart contracts.

### RELATED APPLICATION(S)

This application claims the benefit of U.S. Provisional Application No. 62/430,646, filed on 6 Dec. 2016; the contents of which are incorporated herein by reference.

This application is also a continuation-in-part of U.S. application Ser. No. 15/699,663, filed on 8 Sep. 2017, which claims the benefit of U.S. Provisional Application No. 62/385,517, filed on 9 Sep. 2016, and U.S. Provisional Application No. 62/385,533, tiled on 9 Sep. 2016; their entire contents of which are incorporated herein by reference.

### TECHNICAL FIELD

This disclosure relates to asset transfer systems and, more particularly, to asset transfer systems that utilize a ledger system.

### BACKGROUND

Businesses function in a global economy and assets are often transferred between these companies. Accordingly, a first company may invoice a second company, wherein payments may be made by transferring assets (e.g., funds) from a bank account of the second company to a bank account of the first company.

Unfortunately, such transactions are often slow to effectuate for various reasons. For example, many individual entities (e.g., banks) may be involved that may require multiple discrete transfers in order to effectuate the complete transfer. Additionally, each one of these discrete transfers may induce a delay, as the individual entities may wait for their transfer to settle before the next transfer may begin.

### SUMMARY OF DISCLOSURE

In one implementation, a computer-implemented method for effectuating an asset transfer between a plurality of banks is executed on a computing device and includes generating a plurality of linked smart contracts, wherein the plurality of linked smart contracts includes: a first smart contract within a first banking network, and a second smart contract within a second banking network. The asset transfer between the plurality of banks is processed via the plurality of linked smart contracts.

One or more of the following features may be included. The asset transfer may be settled via at least one central bank associated with at least one of the plurality of banks. At least one distributed ledger may be updated to memorialize the asset transfer between the plurality of banks. Settling the asset transfer via at least one central bank associated with at least one of the plurality of banks may include: settling the asset transfer via a first central bank associated with a market maker and a first bank included within the plurality of banks; and settling the asset transfer via a second central bank associated with the market maker and a second bank included within the plurality of banks. Updating at least one distributed ledger to memorialize the asset transfer between the plurality of banks may include: updating a first distributed ledger to memorialize the asset transfer between the first bank and the market maker, and updating a second distributed ledger to memorialize the asset transfer between the second bank and the market maker. The plurality of banks may include at least one commercial bank. The asset transfer may be an international asset transfer between a first country and a second country and the plurality of banks may include: a first commercial bank in the first country; a second commercial bank in the second country; and a market maker that allows for asset transfers between the first country and the second country. The plurality of banks may include: a first commercial bank on the first banking network; a second commercial bank on the second banking network; and a market maker on the first banking network and the second banking network. Processing the asset transfer between the plurality of banks via the plurality of linked smart contracts may include: executing the first smart contract to effectuate the asset transfer from the first commercial bank to the market maker, and executing the second smart contract to effectuate the asset transfer from the market maker to the second commercial bank. Processing the asset transfer between the plurality of banks via the plurality of linked smart contracts further may include confirming the existence of the second smart contract prior to executing the first smart contract. Processing the asset transfer between the plurality of banks via the plurality of linked smart contracts further may include confirming that the first smart contract was executed prior to executing the second smart contract.

In another implementation, a computer program product resides on a computer readable medium and has a plurality of instructions stored on it. When executed by a processor, the instructions cause the processor to perform operations including generating a plurality of linked smart contracts, wherein the plurality of linked smart contracts includes: a first smart contract within a first banking network, and a second smart contract within a second banking network. The asset transfer between the plurality of banks is processed via the plurality of linked smart contracts.

One or more of the following features may be included. The asset transfer may be settled via at least one central bank associated with at least one of the plurality of banks. At least one distributed ledger may be updated to memorialize the asset transfer between the plurality of banks. Settling the asset transfer via at least one central bank associated with at least one of the plurality of banks may include: settling the asset transfer via a first central bank associated with a market maker and a first bank included within the plurality of banks; and settling the asset transfer via a second central bank associated with the market maker and a second bank included within the plurality of banks. Updating at least one distributed ledger to memorialize the asset transfer between the plurality of banks may include: updating a first distributed ledger to memorialize the asset transfer between the first bank and the market maker, and updating a second distributed ledger to memorialize the asset transfer between the second bank and the market maker. The plurality of banks may include at least one commercial bank. The asset transfer may be an international asset transfer between a first country and a second country and the plurality of banks may include: a first commercial bank in the first country; a second commercial bank in the second country; and a market maker that allows for asset transfers between the first country and the second country. The plurality of banks may include: a first commercial bank on the first banking network; a second commercial bank on the second banking network; and a market maker on the first banking network and the second banking network. Processing the asset transfer between the plurality of banks via the plurality of linked smart contracts may include: executing the first smart contract to effectuate the asset transfer from the first commercial bank to the market maker, and executing the second smart contract to effectuate the asset transfer from the market maker to the second commercial bank. Processing the asset transfer between the plurality of banks via the plurality of linked smart contracts further may include confirming the existence of the second smart contract prior to executing the first smart contract. Processing the asset transfer between the plurality of banks via the plurality of linked smart contracts further may include confirming that the first smart contract was executed prior to executing the second smart contract.

In another implementation, a computing system including a processor and memory is configured to perform operations including generating a plurality of linked smart contracts, wherein the plurality of linked smart contracts includes: a first smart contract within a first banking network, and a second smart contract within a second banking network. The asset transfer between the plurality of banks is processed via the plurality of linked smart contracts.

One or more of the following features may be included. The asset transfer may be settled via at least one central bank associated with at least one of the plurality of banks. At least one distributed ledger may be updated to memorialize the asset transfer between the plurality of banks. Settling the asset transfer via at least one central bank associated with at least one of the plurality of banks may include: settling the asset transfer via a first central bank associated with a market maker and a first bank included within the plurality of banks; and settling the asset transfer via a second central bank associated with the market maker and a second bank included within the plurality of banks. Updating at least one distributed ledger to memorialize the asset transfer between the plurality of banks may include: updating a first distributed ledger to memorialize the asset transfer between the first bank and the market maker, and updating a second distributed ledger to memorialize the asset transfer between the second bank and the market maker. The plurality of banks may include at least one commercial bank. The asset transfer may be an international asset transfer between a first country and a second country and the plurality of banks may include: a first commercial bank in the first country; a second commercial bank in the second country; and a market maker that allows for asset transfers between the first country and the second country. The plurality of banks may include: a first commercial bank on the first banking network; a second commercial bank on the second banking network; and a market maker on the first banking network and the second banking network. Processing the asset transfer between the plurality of banks via the plurality of linked smart contracts may include: executing the first smart contract to effectuate the asset transfer from the first commercial bank to the market maker, and executing the second smart contract to effectuate the asset transfer from the market maker to the second commercial bank. Processing the asset transfer between the plurality of banks via the plurality of linked smart contracts further may include confirming the existence of the second smart contract prior to executing the first smart contract. Processing the asset transfer between the plurality of banks via the plurality of linked smart contracts further may include confirming that the first smart contract was executed prior to executing the second smart contract.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an asset transfer process according to an embodiment of the present disclosure; and

FIG. 2 is a flowchart of an implementation of the asset transfer process of FIG. 1 according to an embodiment of the present disclosure.

Like reference symbols in the various drawings indicate like elements.

### DETAILED DESCRIPTION OF THE PREFERRED EMBODIMENTS

System Overview

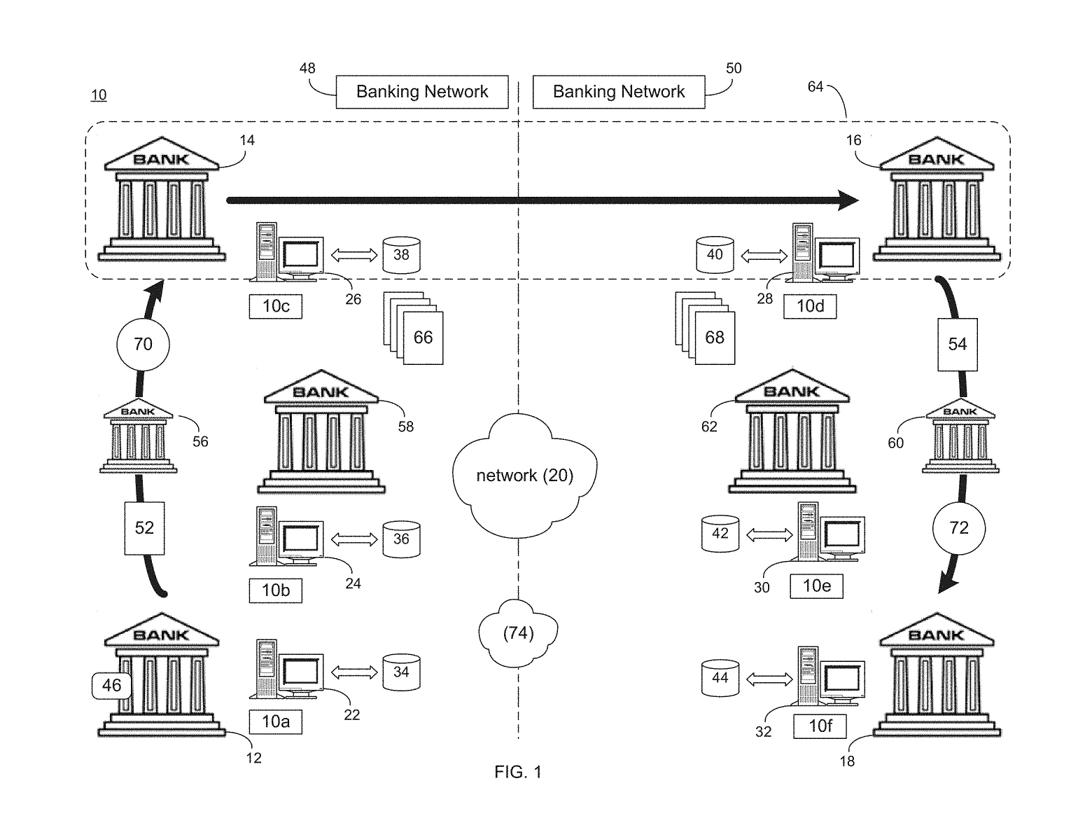

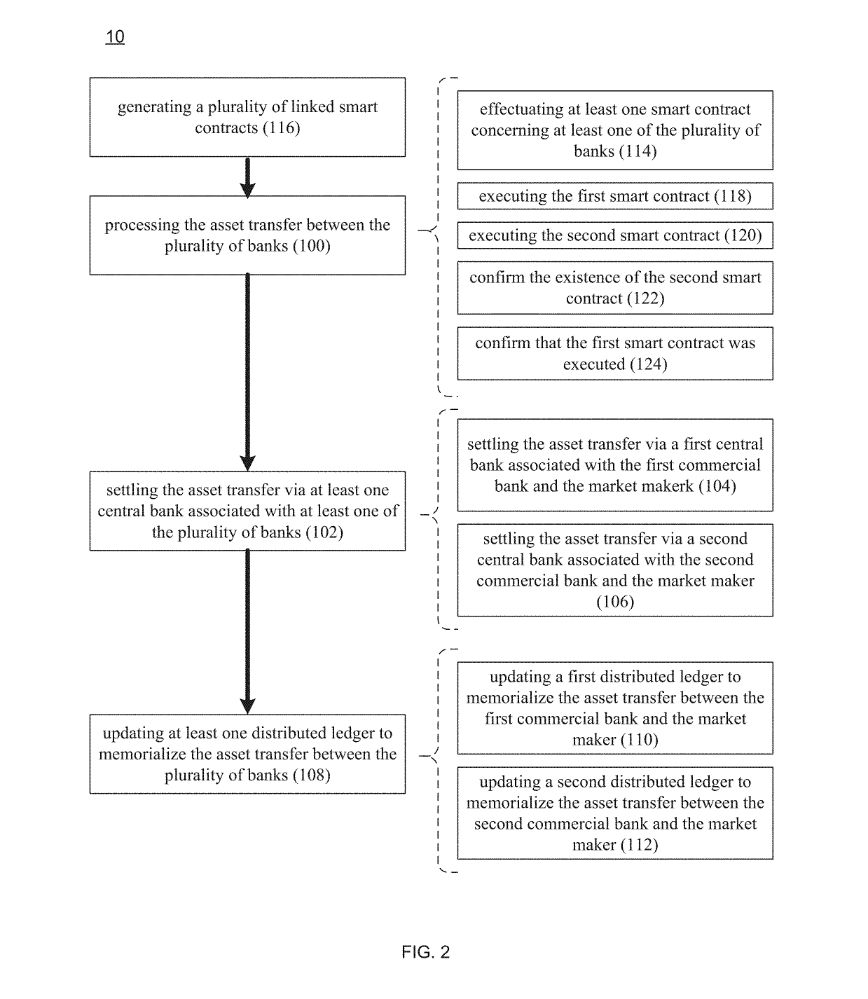

Referring to FIGS. 1-2, there is shown asset transfer process 10. As will be discussed below in greater detail, asset transfer process 10 may be configured to effectuate an asset transfer between a plurality of banks. Examples of such a plurality of banks may include but are not limited to commercial bank 12, commercial bank 14, commercial bank 16, and commercial bank 18.

Asset transfer process 10 may be implemented on a plurality of discrete computing devices via distributed computing network (e.g., network 20). Examples of network 20 may include but are not limited to the Internet, a local area network, or a wide area network. Network 20 may be connected to one or more secondary networks (not shown) or may be a portion of a larger network.

For this example and for illustrative purposes only, asset transfer process 10 is shown to be implemented on six computing devices (e.g., computing devices 22, 24, 26, 28, 30, 32) that are coupled via network 20, wherein each of computing devices 22, 24, 26, 28, 30, 32 may implement some or all of asset transfer process 10. Examples of computing devices 22, 24, 26, 28, 30, 32 may include, but are not limited to: a personal computer, a laptop computer, a notebook computer, a personal digital assistant, a smartphone, a server computer, a series of server computers, a mini computer, a mainframe computer, or a cloud-based computing network.

While in this particular example, asset transfer process 10 is shown to be implemented on six computing devices (e.g., computing devices 22, 24, 26, 28, 30, 32), this is for illustrative purposes only and is not intended to be a limitation of this disclosure, as other configurations are possible. For example, it is understood that the number of computing devices that implement asset transfer process 10 may be increased or decreased depending upon the specific needs, specific requirements and/or design criteria of asset transfer process 10.

Continuing with the above-stated example:
computing device 22 may implement a portion of asset transfer process 10 (e.g., asset transfer process 10a), wherein the instruction sets and subroutines of asset transfer process 10a, which may be stored on storage device 34 coupled to computing device 22, may be executed by one or more processors (not shown) and one or more memory architectures (not shown) included within computing device 22;
computing device 24 may implement a portion of asset transfer process 10 (e.g., asset transfer process 10b), wherein the instruction sets and subroutines of asset transfer process 10b, which may be stored on storage device 36 coupled to computing device 24, may be executed by one or more processors (not shown) and one or more memory architectures (not shown) included within computing device 24;
computing device 26 may implement a portion of asset transfer process 10 (e.g., asset transfer process 10c), wherein the instruction sets and subroutines of asset transfer process 10c, which may be stored on storage device 38 coupled to computing device 26, may be executed by one or more processors (not shown) and one or more memory architectures (not shown) included within computing device 26;
computing device 28 may implement a portion of asset transfer process 10 (e.g., asset transfer process 10d), wherein the instruction sets and subroutines of asset transfer process 10d, which may be stored on storage device 40 coupled to computing device 28, may be executed by one or more processors (not shown) and one or more memory architectures (not shown) included within computing device 28;
computing device 30 may implement a portion of asset transfer process 10 (e.g., asset transfer process 10e), wherein the instruction sets and subroutines of asset transfer process 10e, which may be stored on storage device 42 coupled to computing device 30, may be executed by one or more processors (not shown) and one or more memory architectures (not shown) included within computing device 30; and
computing device 32 may implement a portion of asset transfer process 10 (e.g., asset transfer process 10f), wherein the instruction sets and subroutines of asset transfer process 10f, which may be stored on storage device 44 coupled to computing device 32, may be executed by one or more processors (not shown) and one or more memory architectures (not shown) included within computing device 32.

Examples of storage devices 34, 36, 38, 40, 42, 44 may include but are not limited to: a hard disk drive; a RAID device; a random access memory (RAM); a read-only memory (ROM); and all forms of flash memory storage devices. Computing devices 22, 24, 26, 28, 30, 32 may each execute an operating system, examples of which may include but are not limited to Microsoft Windows™, Android™, WebOS™, iOS™, macOS™, Redhat Linux™, or a custom operating system.

The various computing devices (e.g., computing devices 22, 24, 26, 28, 30, 32) may be directly or indirectly coupled to network 20. For example, one or more of computing devices 22, 24, 26, 28, 30, 32 may be directly coupled to network 20 via a hardwired connection between one or more of computing devices 22, 24, 26, 28, 30, 32 and network 20. Additionally, one or more of computing devices 22, 24, 26, 28, 30, 32 may be wirelessly coupled to network 20 via a wireless communication channel (not shown) established between one or more of computing devices 22, 24, 26, 28, 30, 32 and a cellular network / wireless access point (not shown), which may be directly coupled to network 20.

Asset Transfer Process:

As stated above, asset transfer process 10 may be configured to effectuate an asset transfer between a plurality of banks. Further and as discussed above, examples of such a plurality of banks may include but are not limited to commercial bank 12, commercial bank 14, commercial bank 16, commercial bank 18.

For the following example, assume that commercial bank 12 wishes to transfer assets to commercial bank 18 and, therefore, commercial bank 12 may initiate an asset transfer (e.g., asset transfer 46) to effectuate the transfer of such assets. Asset transfer 46 may be an asset transfer between first banking network 48 (e.g., a banking network, a banking region and/or a banking country) and second banking network 50 (e.g., a banking network, a banking region and/or a banking country). Accordingly, the plurality of banks may include a first commercial bank (e.g., commercial bank 12) in first banking network 48 and a second commercial bank (e.g., commercial bank 18) in second banking network 50.

For this example, assume that a customer of commercial bank 12 (e.g., a US-based commercial bank) wishes to transfer assets 52 (e.g., in US dollars) to a customer of commercial bank 18 (e.g., an India-based commercial bank) as assets 54 (in Indian Rupees).

Accordingly, asset transfer process 10 may process 100 asset transfer 46 between the plurality of banks (e.g., commercial bank 12 and commercial bank 18) and may settle 102 asset transfer 46 via at least one central bank associated with at least one of the plurality of banks (e.g., commercial bank 12 and commercial bank 18).

For example, assume that central bank 56 is associated with commercial bank 12, commercial bank 14 and commercial bank 58. Accordingly, central bank 56 may be configured to effectuate settlement of exchanges between member banks (e.g., commercial banks 12, 14, 58). As is known in the art, a central bank (e.g., central bank 56) may be a monetary authority (e.g., a monopolized or nationalized institution) that controls the production and distribution of money and credit. In modern economies, a central bank (e.g., central bank 56) may be responsible for the formulation of monetary policy and the regulation of member banks (e.g., commercial banks 12, 14, 58). As commercial bank 12 (in this example) is a US-based commercial bank, an example of central bank 56 may include the United States Federal Reserve System, wherein central bank 56 may be configured to effectuate account-based transfers between member banks (e.g., commercial banks 12, 14, 58). Specifically, central bank 56 may be configured to maintain individual accounts for member banks (e.g., commercial banks 12, 14, 58), wherein asset transfers (in US dollars) from one member bank to another member bank may be effectuated by debiting the account of the transferring member bank a defined quantity of US dollars and crediting the account of the receiving member bank the same defined quantity of US dollars.

Further, assume that central bank 60 is associated with commercial bank 16, commercial bank 18 and commercial bank 62. Accordingly, central bank 60 may be configured to effectuate settlement of exchanges between member banks (e.g., commercial banks 16, 18, 62). As commercial bank 18 (in this example) is an India-based commercial bank, an example of central bank 60 may include the Reserve Bank of India, wherein central bank 60 may be configured to effectuate account-based transfers between member banks (e.g., commercial banks 16, 18, 62). Specifically, central bank 60 may be configured to maintain individual accounts for member banks (e.g., commercial banks 16, 18, 62), wherein asset transfers (in Indian Rupees) from one member bank to another member bank may be effectuated by debiting the account of the transferring member bank a defined quantity of Indian Rupees and crediting the account of the receiving member bank the same defined quantity of Indian Rupees.

As discussed above, asset transfer 46 may be an asset transfer between first banking network 48 and second banking network 50. When effectuating such an asset transfer, at least one of the plurality of banks (e.g., commercial banks 12, 14, 16, 18) may be a market maker (e.g., a trader/dealer that maintains bank accounts in multiple banking networks) that allows for asset transfers between first banking network 48 and second banking network 50.

Continuing with the above-stated example in which commercial bank 12 wishes to transfer assets to commercial bank 18, assume that commercial bank 14 and commercial bank 16 are related, in that commercial bank 14 is the US-based portion of international bank 64 and commercial bank 16 is the Indian-based portion of international bank 64. Accordingly, the combination of commercial bank 14 (the US-based portion of international bank 64) and commercial bank 16 (the Indian-based portion of international bank 64) may function as a market maker to allow for asset transfers between (in this example) the United States of America and India. Other examples of such a market maker may include but is not limited to: a bank that maintains a nostro account, wherein a nostro account is an account that allows a bank of a first country to maintain an account that holds and trades the currency of a second country; or a trader/dealer that maintains bank accounts in multiple countries.

Continuing with the above-stated example, assume that commercial bank 12 (e.g., a US-based commercial bank) wishes to transfer assets 52 (e.g., $10,000 US dollars) to commercial bank 18 (e.g., an Indian-based commercial bank) as assets 54. As commercial bank 18 is an Indian-based commercial bank, transferred assets 52 (e.g., $10,000 US dollars) cannot be directly transferred to commercial bank 18 and must first be converted to assets 54 (e.g., Indian Rupees). Accordingly, international bank 64 (e.g., commercial bank 14 and commercial bank 16) may be utilized by asset transfer process 10 to function as a market maker and effectuate the transfer.

Accordingly, asset transfer process 10 may process 100 asset transfer 46 between the plurality of banks (e.g., commercial bank 12 and commercial bank 18) and may settle 102 asset transfer 46 via at least one central bank associated with at least one of the plurality of banks (e.g., commercial bank 12 and commercial bank 18).

As will be discussed below in greater detail, when settling 102 the asset transfer via at least one central bank associated with at least one of the plurality of banks, asset transfer process 10 may settle 104 the asset transfer (e.g., asset transfer 46) via a first central bank (e.g., central bank 56) associated with the first commercial bank (e.g., commercial bank 12) and the third commercial bank (e.g., commercial bank 14 of international bank 64); and may settle 106 the asset transfer (e.g., asset transfer 46) via a second central bank (e.g., central bank 60) associated with the second commercial bank (e.g., commercial bank 18) and the third commercial bank (e.g., commercial bank 16 of international bank 64).

Accordingly and when processing 100 asset transfer 46, asset transfer process 10 may arrange to have $10,000 US dollars transferred from commercial bank 12 to commercial bank 14 via central bank 56.

As discussed, central bank 56 (which is associated with commercial bank 12, commercial bank 14 and commercial bank 58) may be configured to effectuate settlement of exchanges between member banks (e.g., commercial banks 12, 14, 58). Accordingly and when processing 100 asset transfer 46, asset transfer process 10 may utilize central bank 56 to settle 104 the $10,000 account-based transfer from commercial bank 12 to commercial bank 14 by debiting the account of commercial bank 12 by $10,000 while crediting the account of commercial bank 14 by $10,000.

Since international bank 64 (e.g., commercial bank 14 and commercial bank 16) may be utilized (in this example) by asset transfer process 10 to function as a market maker and effectuate the currency exchange, upon the account associated with commercial bank 14 being credited $10,000 from commercial bank 12, asset transfer process 10 may convert this $10,000 into Indian Rupees (which currently converts to 640,700 Rupees). Accordingly, asset transfer process 10 may credit an account within central bank 60 that is associated with commercial bank 16 by 640,700 Rupees while debiting the account within central bank 56 that is associated with commercial bank 14 by $10,000.

In order to complete the $10,000 transfer from commercial bank 12 to commercial bank 18 (and upon the account within central bank 60 that is associated with commercial bank 16 being credited 640,700 Rupees), asset transfer process 10 may utilize central bank 60 to settle 106 the 640,700 Rupees account-based transfer from commercial bank 16 to commercial bank 18 by debiting the account of commercial bank 16 by 640,700 Rupees while crediting the account of commercial bank 18 by 640,700 Rupees.

Ledgering:

Asset transfer process 10 may update 108 at least one distributed ledger (e.g., ledger 66 and/or ledger 68) to memorialize asset transfer 46 between the plurality of banks (e.g., commercial bank 12 and commercial bank 18). One example of such a distributed ledger (e.g., ledger 66 and/or ledger 68) may include but is not limited to a blockchain ledger.

As is known in the art, a blockchain ledger may be a continuously growing list of records (e.g., called blocks) that are linked and secured using cryptography. For example, each block within a blockchain may contain a hash pointer as a link to a previous block. Accordingly, blockchains may be inherently resistant to modification of the data, as each block in the chain is linked (via a hash function) to the previous block in the chain. Accordingly, a block may include transaction data, a hash function that identifies the previous block in the blockchain ledger, and a time/date stamp. Functionally, a blockchain ledger may serve as an open, distributed ledger that may securely record transactions between two parties (e.g., commercial banks) efficiently and in a verifiable and permanent way.

As will be explained below in greater detail, when updating 108 at least one distributed ledger (e.g., ledger 66 and/or ledger 68) to memorialize asset transfer 46 between the plurality of banks (e.g., commercial bank 12 and commercial bank 18), asset transfer process 10 may update 110 a first distributed ledger (e.g., ledger 66) to memorialize the asset transfer between the first commercial bank (e.g., commercial bank 12) and the third commercial bank (e.g., commercial bank 14 of international bank 64), and may update 112 a second distributed ledger (e.g., ledger 68) to memorialize the asset transfer between the second commercial bank (e.g., commercial bank 18) and the third commercial bank (e.g., commercial bank 16 of international bank 64).

Accordingly, asset transfer process 10 may update 110 ledger 66 to memorialize the asset transfer between commercial bank 12 and commercial bank 14 (of international bank 64). Specifically and in the manner described above, asset transfer process 10 may update 110 ledger 66 to include a new block, wherein this new block may include transaction data (e.g., $10,000 as the transfer amount, commercial bank 12 as the transferor, and commercial bank 14 as the transferee), a time/date stamp for the transaction, and a copy of the hash of the previous block in the blockchain ledger. Asset transfer process 10 may then generate a hash of this new block for use within the next block in the blockchain.

As this is a distributed ledger system, a copy of ledger 66 may be calculated and maintained by all interested parties (e.g., commercial banks 12, 14, 58) on computing devices 22, 26, 24 (respectively), wherein each of the interested parties (e.g., commercial banks 12, 14, 58) must compare their newly-calculated block and confirm identical results before the newly-calculated block is added to (in this example) ledger 66.

Further, asset transfer process 10 may update 112 ledger 68 to memorialize the asset transfer between commercial bank 18 and commercial bank 16 (of international bank 64). Specifically and in the manner described above, asset transfer process 10 may update 112 ledger 68 to include a new block, wherein this new block may include transaction data (e.g., 640,700 Rupees as the transfer amount, commercial bank 16 as the transferor, and commercial bank 18 as the transferee), a time/date stamp for the transaction, and a copy of the hash of the previous block in the blockchain ledger. Asset transfer process 10 may then generate a hash of this new block for use within the next block in the blockchain.

As this is a distributed ledger system, a copy of ledger 68 may be calculated and maintained by all interested parties (e.g., commercial banks 16, 18, 62) on computing devices 28, 32, 30 (respectively), wherein each of the interested parties (e.g., commercial banks 16, 18, 62) must compare their newly-calculated block and confirm identical results before the newly-calculated block is added to (in this example) ledger 68.

Smart Contracts:

When processing 100 asset transfer 46 between the plurality of banks (e.g., commercial bank 12 and commercial bank 18), asset transfer process 10 may effectuate 114 at least one smart contract (e.g., smart contracts 70, 72) concerning at least one of the plurality of banks (e.g., commercial bank 12 and commercial bank 18).

Often, the various parties in a transaction (e.g., commercial banks 12, 14, 16, 18) may not know each other and may not trust each other. Accordingly, one or more smart contracts (e.g., smart contracts 70, 72) may be utilized to provide a higher level of security and trust when effectuating asset transfer 46. Specifically and as is known in the art, smart contracts (e.g., smart contracts 70, 72) may be computer protocols/algorithms intended to facilitate, verify and/or enforce the negotiation and/or performance of all or a portion of a contract. Through the use of such smart contracts (e.g., smart contracts 70, 72), various contractual clauses may be made partially (or fully) self-executing, self-authenticating and/or self-enforcing.

Accordingly and when processing 100 asset transfer 46 between the plurality of banks (e.g., commercial bank 12 and commercial bank 18), asset transfer process 10 may effectuate 114 smart contract 70 concerning commercial bank 12 that may be utilized to control e.g., the transfer of assets (e.g., assets 52 in US dollars) between commercial bank 12 and commercial bank 14.

Further and when processing 100 asset transfer 46 between the plurality of banks (e.g., commercial bank 12 and commercial bank 18), asset transfer process 10 may effectuate 114 smart contract 72 concerning commercial bank 18 that may be utilized to control e.g., the transfer of assets (e.g., assets 54 in Indian Rupees) between commercial bank 16 and commercial bank 18.

Smart contracts 70, 72 may be linked together so that the execution of one smart contract triggers the execution of the other smart contract (and vice versa). Accordingly and as will be discussed below in greater detail, the presence of smart contracts 70, 72 may be known to (and reviewable by) asset transfer process 10. Accordingly and prior to effecting any portions of the above-described transfer (e.g., commercial bank 12 to commercial bank 14 and/or commercial bank 16 to commercial bank 18), asset transfer process 10 may examine smart contracts 70, 72 to ensure their presence and proper configuration. Further and when processing 100 asset transfer 46 between the plurality of banks (e.g., commercial bank 12 and commercial bank 18), asset transfer process 10 may effectuate 114 smart contracts 70, 72 to ensure that all parties execute the transfers required to fully effectuate asset transfer 46. Accordingly and through the use of such smart contracts (e.g., smart contracts 70, 72), situations may be avoided where one commercial bank fails to effectuate their transfer (e.g., commercial bank 14 receives $10,000 from commercial bank 12 but commercial bank 16 fails to transfer 640,700 Rupees to commercial bank 18).

As discussed above, smart contracts 70, 72 may be linked together so that the execution of one smart contract triggers the execution of the other smart contracts (and vice versa). Accordingly, asset transfer process 10 may generate 116 a plurality of linked smart contracts (e.g., smart contracts 70, 72), wherein the plurality of linked smart contracts may include a first smart contract (e.g., smart contract 70) within e.g., first banking network 48 and a second smart contract (e.g., smart contract 72) within e.g., second banking network 50.

The plurality of linked smart contracts (e.g., smart contracts 70, 72) may be used to effectuate an asset transfer (e.g., asset transfer 46) between a plurality of banks, wherein this plurality of banks may include: a first commercial bank (e.g., commercial bank 12) on first banking network 48; a second commercial bank (e.g., commercial bank 18) on second banking network 50; and a market maker (e.g., international bank 64) on first banking network 12 and second banking network 18. As discussed above, international bank 64 may include commercial bank 14 (that is the US-based portion of international bank 64) and commercial bank 16 (that is the India-based portion of international bank 64).

Asset transfer process 10 may process 100 the asset transfer (e.g., asset transfer 46) between the plurality of banks (in this example, commercial bank 12 and commercial bank 18) via the plurality of linked smart contracts (in this example, smart contract 70 within first banking network 48 and smart contract 72 within second banking network 50). As discussed above, asset transfer process 10 may settle 102 the asset transfer (e.g., asset transfer 46) via at least one central bank associated with at least one of the plurality of banks (e.g., commercial banks 12, 18) and may update 108 at least one distributed ledger to memorialize the asset transfer (e.g., asset transfer 46) between the plurality of banks (e.g., commercial banks 12, 18).

For example and as discussed above, when settling 102 the asset transfer (e.g., asset transfer 46) via at least one central bank associated with at least one of the plurality of banks (e.g., commercial banks 12, 18), asset transfer process 10 may: settle 104 the asset transfer (e.g., asset transfer 46) via a first central bank (e.g., central bank 56) associated with a market maker (e.g., international bank 64) and a first bank (e.g., commercial bank 12) included within the plurality of banks (e.g., commercial banks 12, 18); and may settle 106 the asset transfer (e.g., asset transfer 46) via a second central bank (e.g., central bank 60) associated with the market maker (e.g., international bank 64) and a second bank (e.g., commercial bank 18) included within the plurality of banks (e.g., commercial banks 12, 18).

Further and as discussed above, when updating 108 at least one distributed ledger to memorialize the asset transfer (e.g., asset transfer 46) between the plurality of banks (e.g., commercial banks 12, 18), asset transfer process 10 may update 110 a first distributed ledger (e.g., ledger 66) to memorialize the asset transfer (e.g., asset transfer 46) between the first bank (e.g., commercial bank 12) and the market maker (e.g., international bank 64), and may update 112 a second distributed ledger (e.g., ledger 68) to memorialize the asset transfer (e.g., asset transfer 46) between the second bank (e.g., commercial bank 18) and the market maker (e.g., international bank 64).

When processing 100 the asset transfer (e.g., asset transfer 46) between the plurality of banks (e.g., commercial banks 12, 18) via the plurality of linked smart contracts (e.g., smart contracts 70, 72), asset transfer process 10 may execute 118 the first smart contract (e.g., smart contract 70) to effectuate the asset transfer (e.g., asset transfer 46) from the first commercial bank (e.g., commercial bank 12) to the market maker (e.g., international bank 64) and may execute 120 the second smart contract (e.g., smart contract 72) to effectuate the asset transfer (e.g., asset transfer 46) from the market maker (e.g., international bank 64) to the second commercial bank (commercial bank 18). Accordingly, smart contract 70 may be configured to effectuate the transfer of assets (e.g., assets 52 in US dollars) from commercial bank 12 to the market maker (e.g., commercial bank 14 (i.e., the US-based portion) of international bank 64); while smart contract 72 may be configured to effectuate the transfer of assets (e.g., assets 54 in Indian Rupees) from the market maker (e.g., commercial bank 16 (i.e., the India-based portion) of international bank 64) to commercial bank 18.

The plurality of linked smart contracts (e.g., smart contracts 70, 72) may be generated 116 by asset transfer process 10 even though there is no unique, specific and/or immediate need for such linked smart contracts (e.g., smart contracts 70, 72). For example, linked smart contracts (e.g., smart contracts 70, 72) may be made available so that a market maker (e.g., international bank 64) may perform an asset transfer (e.g., asset transfer 46) between e.g., first banking network 48 and second banking network 50, wherein (in this example) first banking network 48 is located within the United State and second banking network 50 is located within India.

Additionally and when processing 100 the asset transfer (e.g., asset transfer 46) between the plurality of banks (e.g., commercial banks 12, 18) via the plurality of linked smart contracts (e.g., smart contracts 70, 72), asset transfer process 10 may confirm 122 the existence of the second smart contract (e.g., smart contract 72) prior to executing the first smart contract (e.g., smart contract 70).

Continuing with the above-stated example in which commercial bank 12 (e.g., a US-based commercial bank) wishes to transfer assets 52 (e.g., $10,000 US dollars) to commercial bank 18 (e.g., an India-based commercial bank) as assets 54 (e.g., 640,700 Indian Rupees), asset transfer process 10 may identify smart contract 70 (and linked smart contract 72) as a transfer vehicle for effectuating such asset transfer 46. As discussed above, the various parties in a transaction (e.g., commercial banks 12, 14, 16, 18) may not know each other and may not trust each other. Accordingly, smart contracts 70, 72 may be utilized to provide a higher level of security and trust when effectuating asset transfer 46. Accordingly and once smart contract 70 is identified by asset transfer process 10, asset transfer process 10 may confirm 122 the existence of the linked smart contract (e.g., smart contract 72) prior to executing the first smart contract (e.g., smart contract 70).

For example, commercial bank 12 may reach out (via one or more messages, not shown) to one or more members of second banking network 50 to confirm 122 the existence of smart contract 72. Specifically, commercial bank 12 may ask one or more members of second banking network 50 whether (or not) smart contract 72 exists. For example, commercial bank 12 may ask e.g., commercial bank 62 and/or central bank 60 (both of which are members of second banking network 50) e.g., whether smart contract 72 exists, whether smart contract 72 is associated with (linked to) smart contract 70 and/or whether smart contract 72 is configured to be triggered by the successful execution of smart contract 70.

A certificate authority (e.g., certificate authority 74) may be utilized to define the members of second banking network 50 to which commercial bank 12 may reach out when confirming 122 the existence of smart contract 72. For example, certificate authority 74 may define the IP addresses of commercial bank 62 and/or central bank 60.

While in this particular example, commercial bank 12 is described as inquiring about smart contract 72 from only two members of second banking network 50 (e.g., commercial bank 62 and/or central bank 60), this is for illustrative purposes only and is not intended to be a limitation of this disclosure, as other configurations are possible and are considered to be within the scope of this disclosure. For example, the number of members to which commercial bank 12 may make an inquiry may be increased to provide a higher level of trust with respect to the confirmation sought and received concerning the existence of smart contract 72. Upon receiving such confirmation(s), the authenticity of the same may be confirmed by commercial bank 12 via e.g., private key/public key encryption available through certificate authority 74.

Assuming that an acceptable level of confirmations are received (as defined via e.g., a minimum number or a minimum percentage), commercial bank 12 may populate smart contract 70 with the required information (e.g., name of transferor, name of transferee, quantity of the transfer, etc.) and may execute the same (resulting in the transfer of assets 52 from commercial bank 12 to commercial bank 14 via central bank 56).

As the execution of smart contract 70 is completed and e.g., assets 52 were transferred to commercial bank 14 of international bank 64, commercial bank 12 may trigger the execution of smart contract 72. Accordingly, commercial bank 12 may reach out to members of second banking network 50, triggering smart contract 72. As stated above, the members of second banking network 50 may be identified via certificate authority 74.

Further and when processing 100 the asset transfer (e.g., asset transfer 46) between the plurality of banks (e.g., commercial banks 12, 18) via the plurality of linked smart contracts (e.g., smart contracts 70, 72), asset transfer process 10 may confirm 124 that the first smart contract (e.g., smart contract 70) was executed prior to executing the second smart contract (e.g., smart contract 72).

Accordingly and upon the triggering of smart contract 72, asset transfer process 10 may ask one or more members of first banking network 48 whether (or not) smart contract 70 was executed. For example, the member of second banking network 50 that is triggering smart contract 72 may ask e.g., commercial bank 58 and/or central bank 56 (both of which are members of first banking network 48) e.g., whether smart contract 70 was executed.

Certificate authority 74 may be utilized to define the members of first banking network 48 to which the member of second banking network 50 that is triggering smart contract 72 may reach out when confirming 124 the execution of smart contract 70. For example, certificate authority 74 may define the IP addresses of commercial bank 58 and/or central bank 56.

While in this particular example, the member of second banking network 50 that is triggering smart contract 72 is described as inquiring about smart contract 70 from only two members of first banking network 48 (e.g., commercial bank 58 and/or central bank 56), this is for illustrative purposes only and is not intended to be a limitation of this disclosure, as other configurations are possible and are considered to be within the scope of this disclosure. For example, the number of members of first banking network 48 to which the member of second banking network 50 that is triggering smart contract 72 makes an inquiry may be increased to provide a higher level of trust with respect to the confirmation(s) sought and received concerning the execution of smart contract 70. Upon receiving such confirmation(s), the authenticity of the same may be confirmed by the member of second banking network 50 that is triggering smart contract 72 via e.g., private key/public key encryption available through certificate authority 74.

Assuming that an acceptable level of confirmations are received (as defined via e.g., a minimum number or a minimum percentage), smart contract 72 may be executed (resulting in the transfer of assets 54 from commercial bank 16 to commercial bank 18 via central bank 60.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 20).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

what is claimed is:

1. A computer-implemented method for effectuating an asset transfer between a plurality of banks, executed on a computing device, comprising:
generating a plurality of linked smart contracts, wherein the plurality of linked smart contracts includes:
a first smart contract within a first banking network, and
a second smart contract within a second banking network; and
processing the asset transfer between the plurality of banks via the plurality of linked smart contracts.

2. The computer-implemented method of claim 1 further comprising:
settling the asset transfer via at least one central bank associated with at least one of the plurality of banks; and
updating at least one distributed ledger to memorialize the asset transfer between the plurality of banks.

3. The computer implemented method of claim 2 wherein settling the asset transfer via at least one central bank associated with at least one of the plurality of banks includes:
settling the asset transfer via a first central bank associated with a market maker and a first bank included within the plurality of banks; and
settling the asset transfer via a second central bank associated with the market maker and a second bank included within the plurality of banks.

4. The computer implemented method of claim 2 wherein updating at least one distributed ledger to memorialize the asset transfer between the plurality of banks includes:
updating a first distributed ledger to memorialize the asset transfer between the first bank and the market maker, and
updating a second distributed ledger to memorialize the asset transfer between the second bank and the market maker.

5. The computer-implemented method of claim 1 wherein the plurality of banks includes at least one commercial bank.

6. The computer-implemented method of claim 5 wherein the asset transfer is an international asset transfer between a first country and a second country and the plurality of banks includes:
a first commercial bank in the first country;
a second commercial bank in the second country; and
a market maker that allows for asset transfers between the first country and the second country.

7. The computer implemented method of claim 1 wherein the plurality of banks includes:
a first commercial bank on the first banking network;
a second commercial bank on the second banking network; and
a market maker on the first banking network and the second banking network.

8. The computer implemented method of claim 7 wherein processing the asset transfer between the plurality of banks via the plurality of linked smart contracts includes:
executing the first smart contract to effectuate the asset transfer from the first commercial bank to the market maker, and
executing the second smart contract to effectuate the asset transfer from the market maker to the second commercial bank.

9. The computer implemented method of claim 8 wherein processing the asset transfer between the plurality of banks via the plurality of linked smart contracts further includes:
confirming the existence of the second smart contract prior to executing the first smart contract.

10. The computer implemented method of claim 8 wherein processing the asset transfer between the plurality of banks via the plurality of linked smart contracts further includes:
confirming that the first smart contract was executed prior to executing the second smart contract.

11. A computer program product residing on a computer readable medium having a plurality of instructions stored thereon which, when executed by a processor, cause the processor to perform operations comprising:
generating a plurality of linked smart contracts, wherein the plurality of linked smart contracts includes:
a first smart contract within a first banking network, and
a second smart contract within a second banking network; and
processing the asset transfer between the plurality of banks via the plurality of linked smart contracts.

12. The computer program product of claim 11 further comprising:
settling the asset transfer via at least one central bank associated with at least one of the plurality of banks; and
updating at least one distributed ledger to memorialize the asset transfer between the plurality of banks.

13. The computer program product of claim 12 wherein settling the asset transfer via at least one central bank associated with at least one of the plurality of banks includes:
settling the asset transfer via a first central bank associated with a market maker and a first bank included within the plurality of banks; and
settling the asset transfer via a second central bank associated with the market maker and a second bank included within the plurality of banks.

14. The computer program product of claim 12 wherein updating at least one distributed ledger to memorialize the asset transfer between the plurality of banks includes:
updating a first distributed ledger to memorialize the asset transfer between the first bank and the market maker, and
updating a second distributed ledger to memorialize the asset transfer between the second bank and the market maker.

15. The computer program product of claim 11 wherein the plurality of banks includes at least one commercial bank.

16. The computer program product of claim 15 wherein the asset transfer is an international asset transfer between a first country and a second country and the plurality of banks includes:
a first commercial bank in the first country;
a second commercial bank in the second country; and
a market maker that allows for asset transfers between the first country and the second country.

17. The computer program product of claim 11 wherein the plurality of banks includes:
a first commercial bank on the first banking network;
a second commercial bank on the second banking network; and
a market maker on the first banking network and the second banking network.

18. The computer program product of claim 17 wherein processing the asset transfer between the plurality of banks via the plurality of linked smart contracts includes:
executing the first smart contract to effectuate the asset transfer from the first commercial bank to the market maker, and
executing the second smart contract to effectuate the asset transfer from the market maker to the second commercial bank.

19. The computer program product of claim 18 wherein processing the asset transfer between the plurality of banks via the plurality of linked smart contracts further includes:
confirming the existence of the second smart contract prior to executing the first smart contract.

20. The computer program product of claim 18 wherein processing the asset transfer between the plurality of banks via the plurality of linked smart contracts further includes:
confirming that the first smart contract was executed prior to executing the second smart contract.

21. A computing system including a processor and memory configured to perform operations comprising:
generating a plurality of linked smart contracts, wherein the plurality of linked smart contracts includes:
a first smart contract within a first banking network, and
a second smart contract within a second banking network; and
processing the asset transfer between the plurality of banks via the plurality of linked smart contracts.

22. The computing system of claim 21 further comprising:
settling the asset transfer via at least one central bank associated with at least one of the plurality of banks; and
updating at least one distributed ledger to memorialize the asset transfer between the plurality of banks.

23. The computing system of claim 22 wherein settling the asset transfer via at least one central bank associated with at least one of the plurality of banks includes:
settling the asset transfer via a first central bank associated with a market maker and a first bank included within the plurality of banks; and
settling the asset transfer via a second central bank associated with the market maker and a second bank included within the plurality of banks.

24. The computing system of claim 22 wherein updating at least one distributed ledger to memorialize the asset transfer between the plurality of banks includes:
updating a first distributed ledger to memorialize the asset transfer between the first bank and the market maker, and
updating a second distributed ledger to memorialize the asset transfer between the second bank and the market maker.

25. The computing system of claim 21 wherein the plurality of banks includes at least one commercial bank.

26. The computing system of claim 25 wherein the asset transfer is an international asset transfer between a first country and a second country and the plurality of banks includes:
a first commercial bank in the first country;
a second commercial bank in the second country; and
a market maker that allows for asset transfers between the first country and the second country.

27. The computing system of claim 21 wherein the plurality of banks includes:
a first commercial bank on the first banking network;
a second commercial bank on the second banking network; and
a market maker on the first banking network and the second banking network.

28. The computing system of claim 27 wherein processing the asset transfer between the plurality of banks via the plurality of linked smart contracts includes:
executing the first smart contract to effectuate the asset transfer from the first commercial bank to the market maker, and
executing the second smart contract to effectuate the asset transfer from the market maker to the second commercial bank.

29. The computing system of claim 28 wherein processing the asset transfer between the plurality of banks via the plurality of linked smart contracts further includes:
confirming the existence of the second smart contract prior to executing the first smart contract.

30. The computing system of claim 28 wherein processing the asset transfer between the plurality of banks via the plurality of linked smart contracts further includes:
confirming that the first smart contract was executed prior to executing the second smart contract.
